(19) United States
(12) Patent Application Publication
(10) Pub. No.: US 2022/0268992 A1
(43) Pub. Date: Aug. 25, 2022

(54) PASPOL LIGHT GUIDE AND METHOD FOR MANUFACTURING PASPOL LIGHT GUIDE

(71) Applicant: Lisa Draexlmaier GmbH, Vilsbiburg (DE)

(72) Inventor: Bernhard Bayersdorfer, Baierbach (DE)

(73) Assignee: Lisa Draexlmaier GmbH, Vilsbiburg (DE)

(21) Appl. No.: 17/675,041

(22) Filed: Feb. 18, 2022

(30) Foreign Application Priority Data
Feb. 24, 2021 (DE) 10 2021 104 380.8

(51) Int. Cl. G02B 6/04; B29D 11/00

(52) U.S. Cl. CPC G02B 6/04; B29D 11/00663

(57) ABSTRACT

A method for manufacturing a Paspol light guide includes disposing a plurality of light guides adjacent to one another so that the light guides form a light-guide bundle, disposing an at least partially light-transparent fabric along at least one partial section of the light-guide bundle, sheathing the light-guide bundle by the fabric so that the fabric forms a fabric sleeve, and closing the fabric sleeve along its longitudinal side. When viewed in a cross-section, the fabric sleeve forms a flag protruding from the light-guide bundle.

### CROSS-REFERENCE TO RELATED APPLICATIONS

This application claims priority to and the benefit of DE 10 2021 104 380.8, filed on Feb. 24, 2021. The disclosures of the above applications are incorporated herein by reference.

### FIELD

The present disclosure relates to a method for manufacturing a Paspol light guide as well as a Paspol light guide manufactured according to this method.

The Paspol light guide can also be referred to as “piping light guide” or “beading light guide,” and is characterized by its essentially round cross-section and its flat flag for the purpose of attachment.

### BACKGROUND

The statements in this section merely provide background information related to the present disclosure and may not constitute prior art.

It is already known to provide the illumination of contours in the interior of a motor vehicle, in particular a motor vehicle seat, an instrument panel, or a vehicle-door inner panel, using light guides, on which light effects are to be generated.

In EP 0988179 B1 a light integration of a light guide into an interior fitting is described. Disclosed is an interior fixture wherein an optical waveguide emitting visible light over at least a part of its length is attached in an attachment device. On at least one end of the optical waveguide a light-feed device is provided for introducing light into the optical waveguide, and the optical waveguide is located in a material strip of the attachment device, which material strip forms a light-transparent hollow part. Viewed in cross-section, the attachment device includes a strip part extending away from the ring part and serving as attachment flag. Using this attachment flag, the optical waveguide held in the hollow part is attached to the interior fixture.

With such light-transparent or at least partially light-transparent hollow parts found in use today, it is known that they are configured as plastic sleeves and provide an improved integration of light conductors in interior fittings. Here the plastic sleeves have a particularly easy manufacturing, which is why they are used here by default.

However, in particular in the luxury automobile segment, the use of plastic sleeves for integration of light conductors is generally expressed as having qualitatively poor optical aesthetics. In addition, due to the plastic, a light passing through an at least partially light-transparent plastic sleeve obtains an artificial effect, which makes the entire sense of space significantly more unnatural.

With the arranging of known light conductors along contours in the interior of a motor vehicle, it is also known that with small bending radii in the contour, an inhomogeneous emitting of light from the light guide can result.

This is due to the fact that light guided in the light guide in the region of the bending of the light guide impinges on the circumferential side of the light guide at too steep of an angle of incidence, whereby at this point a greater proportion of light is emitted than is the case at less-bent locations of the light guide. Such locations thus illuminate more brightly than the rest of the light guide. This leads to an unwanted inhomogeneous design.

In order to avoid this inhomogeneity, the light guide is configured with a smaller diameter, so that the angle of incidence of the light in the light guide is smaller at a bend.

However, the possibilities in the design of an interior of a motor vehicle including a known light guide are thus limited to light guides having a small diameter.

Furthermore, it is known to use a plurality of light guides that are then disposed adjacent to one another during the integration in the interior of a motor vehicle. The use of a plurality of light conductors can be used, for example, instead of the use of a single light guide having greater diameter than the plurality of light conductors, in order to compensate for the above-mentioned difficulties in the homogeneous presentation of a light guide in the region of a bend.

However, with the use of a plurality of light guides, it is problematic to provide a homogeneity in the common light image of the plurality of light conductors since their arrangement and fixing with respect to one another and on the respective component in the interior of a motor vehicle is complex in terms of design and manufacturing.

### SUMMARY

This section provides a general summary of the disclosure and is not a comprehensive disclosure of its full scope or all of its features.

The present disclosure provides a method for manufacturing a Paspol light guide, using which a Paspol light guide having optimal appearance and a wide application spectrum is manufacturable with efficient installation using the simplest possible constructive means.

In one form, the method for manufacturing a Paspol light guide comprises the steps of providing a light guide bundle composed of adjacently disposed light guides, disposing an at least partially light-transparent fabric along at least one partial section of the light-guide bundle, encasing the light-guide bundle by the fabric such that the fabric forms a fabric sleeve, wherein the fabric sleeve seen in a cross-section forms a flag emanating from the light-guide bundle for attaching the Paspol light guide, and that the fabric sleeve is closed along its longitudinal side.

According to one form, with the arranging of the light guides adjacent to one another for forming of the light-guide bundle, it is provided in particular that the main extension directions of the light guides can run generally parallel to one another.

According to another form, the fabric sleeve can be formed from a material, i.e., is a material sleeve. The material sleeve has a high-quality effect in the interior of a motor vehicle.

According to yet another form, light emitted by a respective light guide and passing through the partially light-transparent material sleeve has a particularly natural effect, in particular in comparison to known plastic tubes.

According to one form, by a variation of the weave density of the fabric itself, it is possible to confer a variety of different light effects to the fabric sleeve. The fabric can thus be configured, for example, such that only a small portion of light emitted by a light guide can pass through it, but for this purpose a particularly coarse weave is formed in the fabric, whereby light can also shine through the intermediate spaces in the weave. This effect can be highlighted even further by a colored fabric sleeve.

Using the light-guide bundle made from a plurality of light guides, a Paspol light guide manufactured according to the method of the present disclosure can be disposed along a contour in the interior of a motor vehicle, even at particularly small bending radii and provide a homogeneous emitting of light from the light guides. Since a single light guide inherently has a smaller diameter than the entire light-guide bundle, the angle of incidence of the light is kept sufficiently small on the circumference-side contour of a single light guide, so that no undesired emitting of light takes place. The possibilities in the design of an interior of a motor vehicle including an inventive light guide are thus very extensive.

According to one form, the flag of the fabric sleeve serves in particular to attach the Paspol light guide, for example, to a component in the interior of a motor vehicle, so that the Paspol light guide can be held at its position on this component via the flag. This makes possible a simple and reliable installation of the Paspol light guide, in particular at contours, at which a plurality of components or decorative parts meet or connect to one another.

According to another form, the flag can protrude radially from the light-guide bundle, so that an optimal accessibility of the flag is given for the purpose of attaching. The orientation of the flag with respect to the light guide bundle can particularly also be variable, so that the attaching is simplified even further.

According to yet another form, the flag has a width, a length, and a height. The width of the flag defines the extension of the flag, seen in cross-section, away from the light-guide bundle along the contour of the flag. The length of the flag defines the extension of the flag along the longitudinal side of the light guide bundle. The height of the flag defines the extension of the flag, seen in cross-section, transverse to the extension of the width of the flag. To clearly illustrate using the example of a sheet of paper, the height of the flag is equivalent to the paper strength or paper thickness of the sheet of paper. The height can also be correspondingly referred to as the thickness or the strength of the flag.

According to one form, the closing of the fabric sleeve means that, in the transverse direction, the light guides cannot be moved out from the interior of the fabric sleeve, i.e., are held therein in the transverse direction.

According to another form, by attaching the flag to a component in the interior of a motor vehicle, the light guides held in the closed fabric sleeve can thus be affixed to the component.

According to yet another form, it can be provided that the fabric sleeve is closed by ultrasonic weld.

According to one form, the light guides are a strand material wound on coils, which is unwound in defined lengths from such coils in the method of the present disclosure.

According to another form, the fabric can also be a fabric band wound on a coil, which is unwound in defined lengths in the described method of the present disclosure. It is to be provided here in particular that the unwound length of the fabric band corresponds to the unwound length of the light guide, so that a tension-free-as-possible and homogeneous-as-possible sheathing is provided.

According to yet another form, the method can provide that arranging of the light guides adjacent to one another is allowed such that the light guides are guided by a common guide-guiding device. This means that after the through-passage/exit/departure from the guide-guiding device, the light guides are guided close to one another in a manner depending on the geometric design of the guide-guiding device. Here the guide-guiding device can be configured as an eyelet, i.e., be a circular ring, through which each of the light guides is guided. After the exit of the light guide from the guide-guiding device, a spatially closely adjacent arrangement of the light guides is compelled, so that they form the light-guide bundle starting from the exit from the guide-guiding device.

According to one form, the method can provide that the sheathing of the light-guide bundle by the fabric is achieved by a sleeve-guiding device. For this purpose, the sleeve-guiding device includes a bundle-guide for guiding the light-guide bundle, and a fabric-guide for guiding the fabric, wherein the fabric sheathes the light-guide bundle at least regionally after the passing-through of the sleeve-guiding device. Here the fabric-guiding device achieves a combining or a folding-together of the fabric guided through it, wherein a light-guide bundle exiting from the bundle-guide is guided relative to the fabric such that the combining or the folding-together around the light-guide bundle takes place, and thus the sheathing of the light-guide bundle is allowed by the fabric.

According to another form, the bundle guide can be configured as an eyelet, i.e., a circular ring, through which the light-guide bundle is guided. Alternatively, for example, a cross-sectionally V-shaped or L-shaped support is conceivable, in which the light-guide bundle lies.

According to yet another form, the fabric-guide comprises in particular a contour, which on an input side of the sleeve-guiding device at which fabric and light-guide bundles are introduced, a linear or flat cross-sectional contour. The fabric can thereby be inserted as simply as possible. At the output side of the sleeve-guiding device, at which fabric and light-guide bundles are guided out, the fabric-guide at least regionally comprises an L-shaped or U-shaped or nearly O-shaped or O-shaped cross-sectional contour. With the through-guiding of the fabric through the fabric-guide of the sleeve-guiding device, the sheathing of the fabric can thus be at least partially achieved.

According to one form, the sleeve-guiding device and the guide-guiding device can be a component of a common guide unit. This means in particular that the uniting of the light guide and the sheathing of the light guide with the fabric are achieved in directly successive or optionally even simultaneously performed method steps.

According to another form, the protruding flag of the fabric sleeve comprises both of the transverse-side end regions of the fabric, wherein the fabric sleeve is closed in the region of the flag. The closing of the flag can only be provided in a partial region and/or only point-wise along the length of the flag. A continuous closure of the flag can be provided along its entire length.

According to yet another form, the closing of the flag can also be provided only in a partial region and/or only point-wise along the width of the flag. A continuous closure of the flag along the entire width can also be implemented here.

According to one form, a transverse-side end region is understood to be the region of the fabric that does not belong to the region of the fabric defining the contour of the interior of the fabric sleeve. Viewed in cross-section, the transverse-side end region of the fabric is thus respectively the region of the fabric that protrudes end-side after the sheathing of the light-guide bundle by the fabric.

According to another form, the closure of the fabric sleeve in the region of the flag makes it possible that the fabric sleeve is affected independently of the design of the light-guide bundle. Since the flag protrudes from the light-guide bundle and thus extends away from the light-guide bundle, it has no influence on the closing of the flag regardless of how many light guides, and depending on their diameter, are located in the fabric sleeve.

According to yet another form, the fabric sleeve is closed by ultrasonic welds in the region of the flag. Alternatively to the ultrasonic welds, other methods for closing are also conceivable, such as, for example, sewing or gluing.

According to one form, it is also conceivable that the flag of the fabric sleeve comprises only one of the two transverse-side end regions of the fabric. Here the two transverse-side end regions of the fabric are thus not placed flat against each other and closed, but rather the transverse-side outermost end of a first of the two end regions is connected to a transverse-side innermost end of a second transverse-side end region. Viewed in cross-section, only one point-wise contact of the two transverse-side end regions to each other is formed. It is advantageous here that the height of the flag is only half as large as the height of the flag in a form including both transverse-side end regions. This halved height or thickness of the flag makes it possible to facilitate and/or simplify the attaching of the Paspol light guide to a component in a motor vehicle.

According to another form, the method can comprise a further method step subsequent to the closing of the fabric sleeve, in which a separating of the Paspol light guide is achieved, so that a Paspol light guide having defined length is manufacturable. Such a separating of the Paspol light guide can also fulfill the purpose of providing a flush end of the light guide, which designs a supplying of light into the light guide in a constructively simpler manner. Alternatively thereto, an additional method step is provided that comprises producing a flushness of at least the plurality of light-guide ends with respect to each other after an end of a Paspol light guide is separated, for example.

According to one form, a further method step comprises connecting a closure element to a longitudinal end of the Paspol light guide. The closure element connects the Paspol light guide to a light source. The closure element can be designed cylindrical so that the Paspol light guide is disposed sectionally with its longitudinal end in the closure element. The closure element is thus inserted like a sleeve over the longitudinal end of the Paspol light guide. A connection between the longitudinal end of the Paspol light guide and the closure element can be allowed in particular such that the closure element is pressed together and plastically deformed, whereby a press-fit connection to the Paspol light guide arises. However, it is also conceivable that, for example, an interference-fit, friction-fit and/or materially-bonded connection is achieved between the end of the Paspol light guide and the closure element.

According to another form, a closure element is provided on both ends of the Paspol light guide.

According to yet another form, the method further comprises stamping at least one of the light guides of the Paspol light guide by a stamping unit prior to the mutually adjacent arranging of the light guides. This roughens at least one partial region of the surface of the light guide. The roughening or stamping of the surface allows an emitting of a portion of the light guided by the respective light guide, so that it can escape from the light guide. It can be determined by the selection of the roughness or the stamping, which length of the light guide a homogeneous emission of light is allowed therefrom, and with which strength the light exits here in defined regions along the light guide.

According to one form, a plurality of light guides are stamped by the stamping unit. It is thus of course not excluded that different stamping units can also be used for different light guides. A stamping unit generally comprises two stamping rollers disposed axially parallel to each other, wherein a corresponding light guide to be stamped is guided through them between their radially outer sides. The two rollers thus provide a stamping of the light guide at opposing angles with respect to the circumference of the light guide.

It is advantageous in this form of the stamping unit that the stamping is to be implemented by purely mechanical stamping, since it is only under pressure that the rough surface of the rollers is stamped onto the light guide.

A light guide can be guided successively in particular through a plurality of such stamping units, wherein the stamping units are configured differently such that each allows a stamping in a different angle with respect to the circumference of the light guide. Three such stamping units disposed in series can be particularly provided, wherein a first stamping unit stamps at an angle of 0° and 180°, a second stamping unit stamps at an angle of 60° and 240°, and a third stamping unit stamps at an angle of 120° and 300°.

A uniform as possible stamping on substantially the entire surface of the respective light guide can thereby be allowed.

According to another form, at least two light guides for forming the light-guide bundle can be disposed adjacent to each other and connected to each other. This means that the surfaces of the light guide are at least indirectly connected to each other, in particular abut against each other. “Connected to each other” can mean, for example, interwoven with each other. With a forming of the light-guide bundle from exactly two light guides, interweaving can be an intertwining. One advantage of this interweaving is given in particular when a plurality of light guides are illuminated with differently colored light. Here the interweaving provides that a certain regularity is achievable in the color image.

Furthermore, the present disclosure comprises a Paspol light guide manufactured according to the method of the present disclosure. The Paspol light guide comprises a plurality of light guides disposed adjacent to each other, so that they form a light-guide bundle, which is sheathed in an at least partially light-transparent fabric in the form of a fabric sleeve. In addition, the fabric sleeve is closed along its longitudinal side.

According to one form of the Paspol light guide, at least one of the light guides of the light guide bundle can have a different cross-section than the other light guides of the light-guide bundle. A “different cross-section” is understood to be a differently sized cross-sectional surface, wherein it is not excluded that a “different cross-section” can alternatively or additionally also mean a different shape of the cross-section. The use of light guides having different cross-sections makes it possible, for example, that intermediate spaces between identically sized light guides are filled with smaller light guides such that the packing density of light guides in the fabric sleeve is advantageously high.

According to another form, with the Paspol light guide, it can be provided that a cross-sectional surface of an interior of the fabric sleeve has a size A, and a summed cross-sectional surface of all light guides has a common size B, wherein the following applies:

$$B / A = 0.5 … 1.$$

With light guides having the same diameter, the precise ratio is only dependent on the number of light guides.

It is advantageous in general when the light guides fill a highest-possible proportion of the cross-sectional surface of the fabric sleeve, so that the entire component of the Paspol light guide has a smallest-possible installation-space requirement, and/or it is provided that the light guides cannot move too much in the fabric sleeve for the purpose of providing an optimized-as-possible homogeneity in the light output of the Paspol light guide.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a Paspol light guide manufactured according to a method of the present disclosure;

FIG. 2 is a system for manufacturing a Paspol light guide according to a method of the present disclosure; and

FIG. 3 is a cross-sectional view of a Paspol light guide manufactured according to a method of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

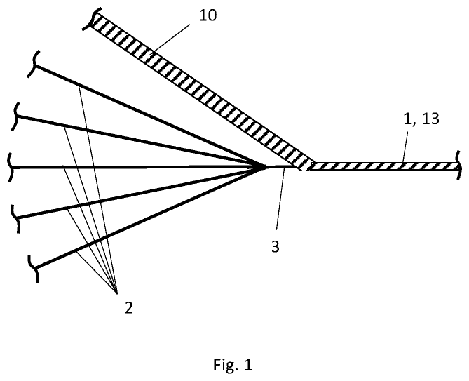

FIG. 1 provides a schematic view of a Paspol light guide 1 manufactured according to a method of the present disclosure.

In FIG. 1, five individual light guides 2 and a fabric 10 designed as a fabric band can be seen as an example. Any number of light guides 2 can be used.

The five light guides 2 are disposed adjacent to one another so that they form a light-guide bundle 3. Laterally, along the longitudinal side of the light-guide bundle 3, the partially light-transparent fabric 10 is disposed along a partial section of the light-guide bundle 3. The fabric 10 is then laid around the light-guide bundle 3 such that it sheathes it and forms a fabric sleeve 13 surrounding the light guide 2. A subsequent fixed closing of the fabric sleeve 13 consequently forms the Paspol light guide 1.

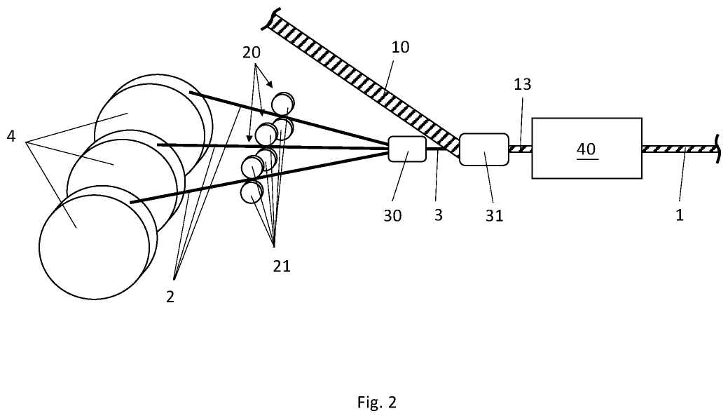

FIG. 2 provides a system for manufacturing a Paspol light guide according to a method of the present disclosure .

The basic design of FIG. 2 corresponds to that of FIG. 1, with the difference being only three light guides 2 are used.

The three light guides 2 are wound as strand material on coils 4, and for the method are unwound therefrom in a defined length. The fabric 10 configured as a fabric band can also be provided unwound from a coil.

A separate stamping unit 20 is respectively associated with the light guides 2 unwound by the coils 4, so that after they are guided through their respective stamping unit 20 the light guides 2 have an at least partially stamped surface, from which a light that is guidable through the light guide 2 is emitted. A stamping unit 20 comprises two stamping rollers 21 disposed axially parallel to each other. A light guide 2 to be stamped is guided between the radially outer sides of the stamping rollers 21, so that under pressure a rough surface of the stamping rollers 21 allows a stamping on the surface of the light guide 2.

The stamped light guides 2 are consequently guided in a common guide-guiding device 30, so that after the exit from the guide-guiding device 30, the light guides 2 are guided close to one another. This means that after the exit of the light guides 2 from the guide-guiding device 30, a spatially closely adjacent arrangement of the light guides 2 is compelled, so that starting from the exit from the guide-guiding device 30, they form the light-guide bundle 3.

The light-guide bundle 3 and the fabric 10 configured as a fabric band are subsequently inserted in a sleeve-guiding device 31. In the sleeve-guiding device 31, it is allowed that the light-guide bundle 3 is encased by the fabric 10. For this purpose, the sleeve-guiding device 31 forms a bundle-guide not depicted here, through which the light-guide bundle 3 is guided, and a fabric-guide not depicted here, through which the fabric 10 is guided. In the fabric-guide, a combining or a folding-together of the fabric 10 guided through it is allowed, and the bundle-guide guides the light-guide bundle 3 relative to the fabric 10 such that the combining or the folding-together of the fabric 10 takes place around the light-guide bundle 3, so that a sheathing of the light-guide bundle 3 is achieved by the fabric 10.

A light-guide bundle 3 thus emerges from the sleeve-guiding device 31, around which a not-yet-closed fabric sleeve 13 has been formed.

The light-guide bundle 3 including the not-yet-closed fabric sleeve 13 is subsequently guided into a welding unit 40, wherein the fabric sleeve 13 is fixedly closed using a welding process, e.g., by ultrasonic welds. Thus, without further intervention, in the sense of a reopening of the fabric sleeve 13, none of the light guides 2 can be moved out again from the interior of the fabric sleeve 13 in the transverse direction.

Thus, in FIG. 2, a Paspol light guide 1 is manufactured according to the form of the method disclosed herein.

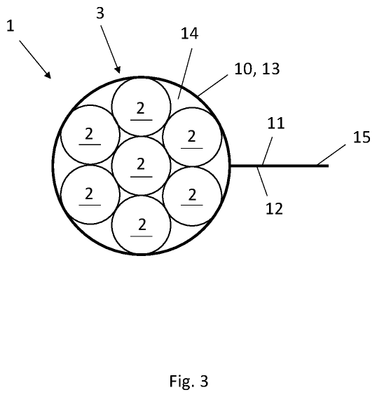

FIG. 3 shows a cross-sectional view of a Paspol light guide 1 manufactured according to a method of the present disclosure. As an example, the Paspol light guide 1 comprises a light-guide bundle 3 formed from seven light guides 2, which light-guide bundle 3 is disposed in the interior 14 of the fabric sleeve 13. All seven light guides 2 have the same cross-section. The section of the fabric sleeve 13 defining the interior 14, and the seven light guides 2 disposed therein, provide a circular design. The diameter of a light guide 2 corresponds to exactly one third of the diameter of the interior 14 of the fabric sleeve 13, so that a cross-sectional surface of the interior 14 of the fabric sleeve 13 has a size A, and a summed cross-sectional surface of all seven light guides 2 has a common size B, wherein in this example it applies that: B/A=0.777

The seven light guides 2 thus have an advantageously high proportion of the cross-sectional surface of the fabric sleeve 13, so that the entire component of the Paspol light guide 1 thus has a smallest possible installation space requirement, and it is provided that the light guides 2 cannot move too much in the fabric sleeve 13. An optimized-as-possible homogeneity is thereby provided in the light output of the Paspol light guide 1.

The fabric sleeve 13 also forms a radially protruding flag 15. This is comprised of a first transverse-side end region 11 of the fabric sleeve 13 and a second transverse-side end region 12 of the fabric sleeve 13, which protrude by the fabric 10 during the method step of the sheathing of the light-guide bundle 3.

The closing of the fabric sleeve 13 is achieved in the region of the flag 15. The first transverse-side end region 11 of the fabric sleeve 13 and the second transverse-side end region 12 of the fabric sleeve 13 are thus connected to each other. This can be achieved, for example, by welding, sewing, or gluing.

The flag 15 is provided so that the Paspol light guide 1 is attached by it to components such as interior panels.

Using constructively simple means, the method for manufacturing a Paspol light guide 1 provides a Paspol light guide 1 that provides an optimal appearance with wide application spectrum and an efficient installation.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for manufacturing a Paspol light guide, the method comprising:
disposing a plurality of light guides adjacent to one another so that the light guides form a light-guide bundle;
disposing of an at least partially light-transparent fabric along at least one partial section of the light-guide bundle;
sheathing the light-guide bundle by the at least partially light-transparent fabric, so that the at least partially light-transparent fabric forms a fabric sleeve, wherein viewed in cross-section, the fabric sleeve forms a flag protruding from the light-guide bundle, the flag being configured to attach the Paspol light guide; and
closing the fabric sleeve along its longitudinal side.

2. The method according to claim 1, wherein the adjacent disposing of the light guides is allowed such that the light guides are guided by a common guide-guiding device.

3. The method according to claim 1, wherein the sheathing of the light-guide bundle by the at least partially light-transparent fabric is achieved by a sleeve-guiding device, the sleeve-guiding device including a bundle-guide for guiding the light-guide bundle and a fabric-guide for guiding the at least partially light-transparent fabric, and wherein the at least partially light-transparent fabric at least regionally sheathes the light-guide bundle after passing-through of the sleeve-guiding device.

4. The method according to claim 1, wherein the flag of the fabric sleeve comprises both transverse-side end regions of the at least partially light-transparent fabric, wherein the fabric sleeve is closed in a region of the flag.

5. The method according to claim 1, further comprising separating the Paspol light guide subsequent to the closing of the fabric sleeve, so that the Paspol light guide having defined length is manufacturable.

6. The method according to claim 1, further comprising connecting the Paspol light guide to a light source by a closure element, the closure element connected to a longitudinal end of the Paspol light guide.

7. The method according to claim 1, further comprising stamping at least one light guide of the light guides of the Paspol light guide by a stamping unit before the adjacent disposing of the light guides such that roughening of the at least one light guide in at least one partial region of a surface of the at least one light guide is achieved.

8. The method according claim 1, wherein at least two light guides forming the light-guide bundle are disposed adjacent to one another and are connected to one another.

9. A Paspol light guide comprising:
a plurality of light guides disposed adjacent to one another so that the light guides form a light-guide bundle; and
a fabric sleeve encasing the light-guide bundle and fixedly closed along its longitudinal side, the fabric sleeve comprising an at least partially light-transparent fabric,
wherein viewed in a cross-section, the fabric sleeve forms a flag protruding from the light-guide bundle, the flag being configured to attach the Paspol light guide.

10. The Paspol light guide according to claim 9, wherein at least one of the light guides of the light-guide bundle has a different cross-section than the other light guides of the light-guide bundle.

11. The Paspol light guide according to claim 9, wherein a cross-sectional surface of an interior of the fabric sleeve has a size A, and a summed cross-sectional surface of all light guides has a common size B, wherein the following applies:
$$B / A = 0.5 … 1.$$
